(19) United States
(12) Patent Application Publication
(10) Pub. No.: US 2015/0365538 A1
(43) Pub. Date: Dec. 17, 2015

(54) COST-COGNITIVE BASE STATION APPARATUS, COST-COGNITIVE USER TERMINAL, AND COST-COGNITIVE NETWORK METHOD

(71) Applicant: ELECTRONICS AND TELECOMMUNICATIONS RESEARCH INSTITUTE, Daegeon-si (KR)

(72) Inventors: Seok Jin YOON, Daejeon-si (KR); Sung Ho IM, Daejeon-si (KR); Kyung Hee LEE, Daejeon-si (KR); Hyung Seok LEE, Daejeon-si (KR); Do Hyung KIM, Daejeon-si (KR); Jin Suk MA, Daejeon-si (KR); Jae Ho LEE, Daejeon-si (KR); Cheol RYU, Daejeon-si (KR); Choong Bum PARK, Daejeon-si (KR); Jae Bok PARK, Daejeon-si (KR); Jae Guk GWON, Daejeon-si (KR)

(21) Appl. No.: 14/737,659

(22) Filed: Jun. 12, 2015

(30) Foreign Application Priority Data
Jun. 12, 2014 (KR) 10-2014-0071674

(51) Int. Cl. H04M 15/00; H04W 4/24; H04W 76/06; H04W 24/08; H04L 12/26

(52) U.S. Cl. CPC H04M 15/8027; H04W 24/08; H04L 43/0882; H04W 76/06; H04W 4/24

(57) ABSTRACT

A cost-cognitive base station apparatus, a cost-cognitive user terminal, and a cost-cognitive network method, in which by recognizing costs based on network congestion, a user may select and receive appropriate network services, thereby reducing telecommunication expenses and inducing the user to a less congested network, which leads to improved network management efficiency.

### CROSS-REFERENCE TO RELATED APPLICATION(S)

This application claims priority from Korean Patent Application No. 10-2014-0071674, filed on Jun. 12, 2014, in the Korean Intellectual Property Office, the entire disclosure of which is incorporated herein by reference for all purposes.

### BACKGROUND

1. Field

The following description relates generally to a cognitive radio technology, and more particularly to a cost-cognitive base station apparatus, a cost-cognitive user terminal, and a cost-cognitive network method.

2. Description of the Related Art

Currently, a network cost model has different characteristics from general goods in that as a network is less frequently used by users, a network management cost is further reduced, and as the network is more frequently used, the network management cost is further increased.

Korean Patent No. 10-1083591 (Nov. 9, 2011) suggests a cost-cognitive technology. The general cognitive radio technology focuses on using available frequency resources, but the present disclosure relates to a cost cognitive technology based on network congestion to enable users to select and receive appropriate network services.

### SUMMARY

Provided are a cost-cognitive base station, a cost-cognitive user terminal, and a cost-cognitive network method, in which by recognizing costs based on network congestion, users may select and receive appropriate network services.

In one general aspect, there is provided a cost-cognitive base station apparatus, including: a network monitor configured to monitor network congestion; a cost packet processor configured to transmit a packet related to network costs to at least one user terminal connected to the cost-cognitive base station apparatus according to the network congestion monitored by the network monitor; and a packet transceiver configured to transmit and receive a packet to/from the at least one user terminal connected to the cost-cognitive base station apparatus.

In response to a congestion degree of a network being greater than a marginal value of 1, the network monitor may determine that the network is congested.

In response to a congestion degree of a network being lower than a marginal value of 2, the network monitor may determine that the network is idle.

In response to a congestion degree of a network being between marginal values of 1 and 2, the network monitor may determine that the network is normal.

In response to the network being congested, the cost packet processor may transmit a packet for increasing network costs.

In response to the network being idle, the cost packet processor may transmit a packet for decreasing network costs.

In response to the network being normal, the cost packet processor may not transmit a packet related to network costs.

In another general aspect, there is provided a cost-cognitive user terminal, including: a packet transceiver configured to transmit and receive a packet to/from a connected base station apparatus; a cost packet detector configured to detect whether the packet received by the packet transceiver is a packet related to network costs; and a cost display component, which in response to the packet related to network costs being detected by the cost packet detector, is configured to display information on the network costs.

In response to detection of the packet related to network costs, the cost-cognitive user terminal may further include a network connection processor configured to determine whether to maintain or release a network connection.

In a case where the packet related to network costs is a packet for increasing network costs, the network connection processor may provide a user interface for a user to manually determine whether to maintain or release the network connection, and based on the determination, the network connection processor may determine whether to maintain or release the network connection.

In a case where the packet related to network costs is a packet for increasing network costs, and in response to the increased network costs being greater than a predetermined threshold, the network connection processor may automatically release the network connection.

In a case where the packet related to network costs is a packet for increasing network costs, the network connection processor may detect other low-cost network and may switch to the detected low-cost network.

In yet another general aspect, there is provided a cost-cognitive network method, including: monitoring network congestion by a cost-cognitive base station apparatus; transmitting, by the cost-cognitive base station apparatus, a packet related to network costs to at least one user terminal connected to the cost-cognitive base station apparatus according to the monitored network congestion; detecting the packet related to network costs by the at least one user terminal that receives the packet from the connected base station apparatus; and in response to detection of the packet related to network costs, displaying information associated with the network costs by the at least one user terminal.

The cost-cognitive network method may further include determining whether to maintain or release the network connection of the at least one user terminal that displays the information associated with the network costs.

The determining whether to maintain or release the network connection may include providing, by the at least one user terminal, a user interface for a user to manually determine whether to maintain or release the network connection, and based on the determination, determining whether to maintain or release the network connection, in a case where the packet related to network costs is a packet for increasing network costs.

The determining whether to maintain or release the network connection may include automatically releasing the network connection in a case where the packet related to network costs is a packet for increasing network costs and in response to the increased network costs being greater than a predetermined threshold.

The determining whether to maintain or release the network connection may include detecting other low-cost network and switching to the detected low-cost network in a case where the packet related to network costs is a packet for increasing network costs.

### BRIEF DESCRIPTION OF THE DRAWINGS

FIG. 1 is a schematic diagram illustrating an example of a cost-cognitive network system.

FIG. 2 is a block diagram illustrating an example of a cost-cognitive base station according to an exemplary embodiment.

FIG. 3 is a block diagram illustrating an example of a cost-cognitive user terminal according to an exemplary embodiment.

FIG. 4 is a block diagram illustrating an example of a cost-cognitive network method according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Terms used throughout this specification are defined in consideration of functions according to exemplary embodiments, and can be varied according to a purpose of a user or manager, or precedent and so on. Therefore, definitions of the terms should be made on the basis of the overall context.

Hereinafter, the apparatus and method for integrating and managing data in a mobile device, and examples of the mobile device will be described in detail with reference to the drawings.

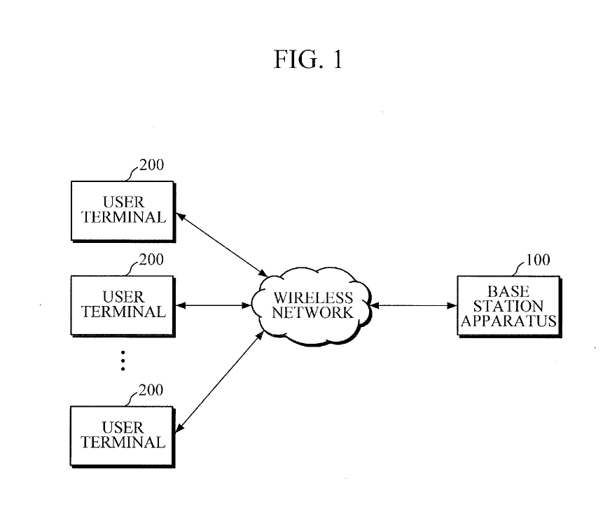

FIG. 1 is a schematic diagram illustrating an example of a cost-cognitive network system. As illustrated in FIG. 1, the cost-cognitive network system includes a cost-cognitive base station apparatus 100, and at least one cost-cognitive user terminal 200 that is connected to the cost-cognitive base station apparatus 100.

Based on network congestion, the cost-cognitive base station apparatus 100 transmits a packet related to a network cost to the at least one cost-cognitive user terminal 200 that is connected to the cost-cognitive base station apparatus 100.

Upon receiving the packet, the cost-cognitive user terminal 200 detects whether the received packet is related to a network cost. If the packet is related to a network cost, the cost-cognitive user terminal 200 displays information associated with the network cost, and determines whether to maintain or release the network connection.

As described above, in the present disclosure, by recognizing costs based on network congestion, users may select and receive appropriate network services, thereby reducing telecommunication expenses, and inducing users to a low-cost network that is less congested.

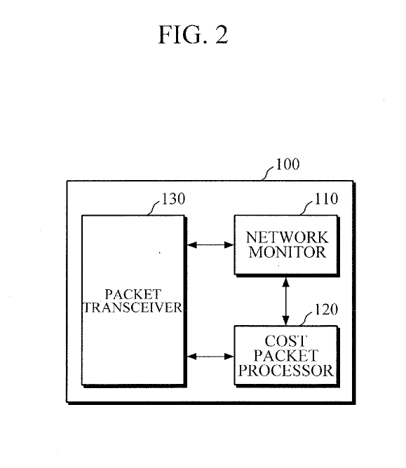

FIG. 2 is a block diagram illustrating an example of a cost-cognitive base station according to an exemplary embodiment. As illustrated in FIG. 2, the cost-cognitive base station apparatus 100 includes a network monitor 110, a cost packet processor 120, and a packet transceiver 130.

The network monitor 110 monitors network congestion. For example, the network congestion may be identified by calculating a congestion degree of a network, and the network congestion degree may be calculated by a method of measuring an amount of packets transmitted and received through the cost-cognitive based station apparatus 100 during a specific period of time.

For example, the network monitor 110 may be configured to determine that a network is congested if a congestion degree of the network is greater than a marginal value of 1; a network is idle if a congestion degree of the network is lower than a marginal value of 2; and a network is normal if a congestion degree of the network lies between marginal values of 1 and 2.

According to the network congestion monitored by the network monitor 110, the cost-packet processor 120 transmits a packet related to a network cost to at least one user terminal 200 that is connected to a base station apparatus.

For example, in the case where a network is congested, the cost-packet processor 120 may be configured to transmit packet for increasing network costs. In the case where a network is idle, the cost-packet processor 120 may be configured to transmit a packet for decreasing network costs. Further, in the case where a network is normal, the cost-packet processor 120 may be configured not to transmit a packet related to network costs.

The packet transceiver 130 transmits and receives packets to/from the user terminal 200 that is connected to a base station apparatus. Data packets or packets related to network costs are transmitted through the packet transceiver 130. In this case, the packet transceiver 130 may transmit a packet related to network costs by including identification information in a packet header indicating that the packet is related to network costs, so that the packet related to network costs may be distinguished from other packets.

As described above, in the present disclosure, by recognizing costs based on network congestion, the cost-cognitive base station apparatus 100 may notify the user terminals 200 connected to the cost-cognitive base station 100 of information associated with network costs.

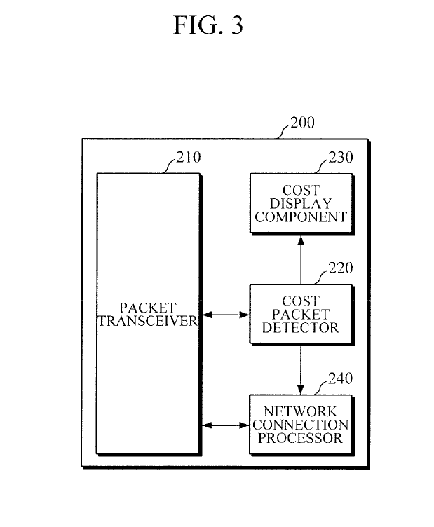

FIG. 3 is a block diagram illustrating an example of a cost-cognitive user terminal according to an exemplary embodiment. As illustrated in FIG. 3, the cost-cognitive user terminal 200 includes a packet transceiver 210, a cost-packet detector 220, and a cost display component 230.

The packet transceiver 210 transmits and receives packets to/from the connected base station apparatus 100. Through the packet transceiver 210, data packets or packets related to network costs are received from the base station apparatus 100 connected to the cost-cognitive user terminal 200.

The cost-cognitive packet detector 220 detects whether a packet received from the packet transceiver 210 is a packet related to network costs. For example, the cost-packet detector 220 may be configured to detect that a received packet is a packet related to network costs based on the identification information included in the packet header indicating that the packet is related to network costs.

Once a packet related to network costs is detected by the cost-packet detector 220, the cost display component 230 displays information associated with network costs. As described above, in the present disclosure, by recognizing costs based on network congestion, the cost-cognitive base station apparatus 100 that recognizes costs based on network congestion transmits information associated with network costs, and the cost-cognitive user terminal 200 receives and displays the information associated with network costs, so that users may identify whether the network costs are increased or decreased.

According to another exemplary embodiment, the cost-cognitive user terminal 200 may further include a network connection processor 240. Once a packet related to network costs is detected, the network connection processor 240 determines whether to maintain or release the network connection.

For example, if a packet related to network costs is a packet for increasing network costs, the network connection processor 240 provides a user interface (not shown) for a user to manually determine whether to maintain or release the network connection, and based on the determination of the user, the network connection processor 240 may maintain or release the network connection.

Alternatively, if a packet related to network costs is a packet for increasing network costs, the network connection processor 240 may automatically release the network connection if the increased network cost is greater than a predetermined threshold.

In another example, if a packet related to network costs is a packet for increasing network costs, the network connection processor 240 may detect other low-cost network, and induce a user to switch to the detected low-cost network.

As described above, in the present disclosure, users may select and receive appropriate network services by recognizing costs based on network congestion, and by analyzing a packet related to network costs that is transmitted from the base station 200 through the cost-cognitive user terminal.

That is, in the present disclosure, as users may select and receive appropriate network services by recognizing costs based on network congestion, thereby reducing telecommunication costs and inducing users to a low-cost network, which leads to improved network management efficiency.

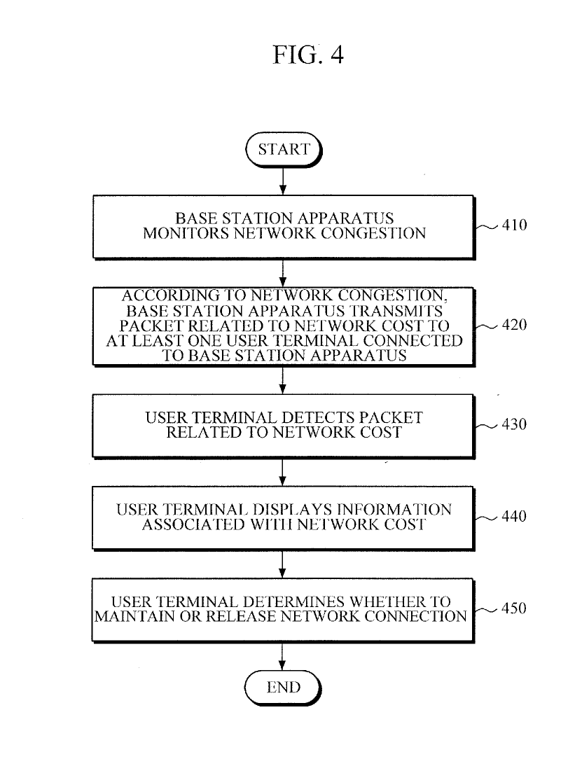

Cost-cognitive network management performed by the above-described cost-cognitive base station apparatus 100 and cost-cognitive user terminal 200 will be described with reference to FIG. 4 below. FIG. 4 is a block diagram illustrating an example of a cost-cognitive network method according to an exemplary embodiment.

First, a base station apparatus monitors network congestion in 410. For example, network congestion may be identified by calculating a congestion degree of a network, and the congestion degree of the network may be calculated by a method of measuring an amount of packets transmitted and received through the base station apparatus during a specific period of time.

For example, the base station apparatus may determine in 410 that a network is congested if a congestion degree of the network is greater than a marginal value of 1; a network is idle if a congestion degree of the network is lower than a marginal value of 2; and a network is normal if a congestion degree of the network lies between marginal values of 1 and 2.

Subsequently, based on the monitored network congestion, the base station apparatus transmits a packet related to network costs to at least one user terminal connected to the base station apparatus in 420.

For example, in the case where a network is congested, the base station apparatus transmits a packet for increasing network costs; in the case where a network is idle, the base station apparatus transmits a packet for decreasing network costs; and in the case where a network is normal, the base station apparatus may be configured not to transmit a packet related to network costs.

The base station apparatus transmits and receives packets to/from connected user terminals, and once a packet is received from the base station apparatus, a user terminal detects a packet related to network costs in 430.

For example, it may be detected in 430 whether a received packet is a packet related to network costs by recognizing identification information included in the packet header indicating that the packet is a packet related to network costs.

Once the packet related to network costs is detected, the user terminal displays information associated with the network costs in 440. In this manner, a user may identify whether the network costs are increased or decreased.

According to another exemplary embodiment, a cost-cognitive network method may include determining in 450 whether to maintain or release the network connection of the user terminal that displays the information associated with the network costs.

For example, in the case where a packet related to network costs is a packet for increasing network costs in 450, the user terminal provides a user interface for a user to manually determine whether to maintain or release the network connection, and based on the determination of the user, the user terminal may determine to maintain or release the network connection.

Alternatively, in the case where a packet related to network costs is a packet for increasing network costs in 450, a user terminal may automatically release the network connection if the increased network cost is greater than a predetermined threshold.

In another example, if a packet related to network costs is a packet for increasing network costs in 450, the user terminal may detect other low-cost network, and induce a user to switch to the detected low-cost network.

As described above, in the present disclosure, by recognizing costs based on network congestion, users may select and receive appropriate network services, thereby reducing telecommunication costs, and inducing them to connect to low-cost network that is less congested, which leads to improved network management efficiency.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cost-cognitive base station apparatus, comprising:
a network monitor configured to monitor network congestion;
a cost packet processor configured to transmit a packet related to network costs to at least one user terminal connected to the cost-cognitive base station apparatus according to the network congestion monitored by the network monitor; and
a packet transceiver configured to transmit and receive a packet to/from the at least one user terminal connected to the cost-cognitive base station apparatus.

2. The apparatus of claim 1, wherein in response to a congestion degree of a network being greater than a marginal value of 1, the network monitor determines that the network is congested.

3. The apparatus of claim 1, wherein in response to a congestion degree of a network being lower than a marginal value of 2, the network monitor determines that the network is idle.

4. The apparatus of claim 1, wherein in response to a congestion degree of a network being between marginal values of 1 and 2, the network monitor determines that the network is normal.

5. The apparatus of claim 2, wherein in response to the network being congested, the cost packet processor transmits a packet for increasing network costs.

6. The apparatus of claim 3, wherein in response to the network being idle, the cost packet processor transmits a packet for decreasing network costs.

7. The apparatus of claim 4, wherein in response to the network being normal, the cost packet processor does not transmit a packet related to network costs.

8. A cost-cognitive user terminal, comprising:
a packet transceiver configured to transmit and receive a packet to/from a connected base station apparatus;
a cost packet detector configured to detect whether the packet received by the packet transceiver is a packet related to network costs; and
a cost display component, which in response to the packet related to network costs being detected by the cost packet detector, is configured to display information on the network costs.

9. The user terminal of claim 8, further comprising a network connection processor, which in response to detection of the packet related to network costs, determines whether to maintain or release a network connection.

10. The user terminal of claim 9, wherein in a case where the packet related to network costs is a packet for increasing network costs, the network connection processor provides a user interface for a user to manually determine whether to maintain or release the network connection, and based on the determination, the network connection processor may determine whether to maintain or release the network connection.

11. The user terminal of claim 9, wherein in a case where the packet related to network costs is a packet for increasing network costs, and in response to the increased network costs being greater than a predetermined threshold, the network connection processor automatically releases the network connection.

12. The user terminal of claim 9, wherein in a case where the packet related to network costs is a packet for increasing network costs, the network connection processor detects other low-cost network, and switches to the detected low-cost network.

13. A cost-cognitive network method, comprising:
monitoring network congestion by a cost-cognitive base station apparatus;
transmitting, by the cost-cognitive base station apparatus, a packet related to network costs to at least one user terminal connected to the cost-cognitive base station apparatus according to the monitored network congestion;
detecting the packet related to network costs by the at least one user terminal that receives the packet from the connected base station apparatus; and
in response to detection of the packet related to network costs, displaying information associated with the network costs by the at least one user terminal.

14. The method of claim 13, further comprising determining whether to maintain or release the network connection of the at least one user terminal that displays the information associated with the network costs.

15. The method of claim 14, wherein the determining whether to maintain or release the network connection comprises providing, by the at least one user terminal, a user interface for a user to manually determine whether to maintain or release the network connection, and based on the determination, determining whether to maintain or release the network connection, in a case where the packet related to network costs is a packet for increasing network costs.

16. The method of claim 14, wherein the determining whether to maintain or release the network connection comprises automatically releasing the network connection in a case where the packet related to network costs is a packet for increasing network costs and in response to the increased network costs being greater than a predetermined threshold.

17. The method of claim 14, wherein the determining whether to maintain or release the network connection comprise detecting other low-cost network and switching to the detected low-cost network in a case where the packet related to network costs is a packet for increasing network costs.
